(19) United States
(12) Patent Application Publication
(10) Pub. No.: US 2004/0121249 A1
(43) Pub. Date: Jun. 24, 2004

(54) Red-colored photosensitive composition and color filter comprising the same

(76) Inventors: Kazuhiro Machiguchi, Osaka (JP); Yuuji Ueda, Osaka (JP); Hiroki Inoue, Nara-ken (JP); Hitohumi Fukushi, Tokyo (JP); Hiroki Endo, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/697,876

(22) Filed: Oct. 31, 2003

(30) Foreign Application Priority Data
Nov. 1, 2002 (JP) P2002-319506

(51) Int. Cl. G02B 5/20

(52) U.S. Cl. 430/7; 430/270.1

(57) ABSTRACT

A positive type red-colored photosensitive composition comprising a colorant, a photo active compound, a curing agent, a solvent and optionally an alkali-soluble resin, wherein the contents of the dye, photo active compound, curing agent and optional alkali-soluble resin are from 55 to 63 parts by weight, from 10 to 30 parts by weight, 10 to 25 parts by weight and 1 parts by weight or less, respectively, per 100 parts by weight of solid components of the photosensitive composition.

### FIELD OF THE INVENTION

The present invention relates to a positive type red-colored photosensitive composition, a color filter produced using such a colored photosensitive composition, and a solid state image pickup device.

### PRIOR ART

A solid state image pickup device comprising a charge-coupled device (CCD) uses color filter (2) having a plurality of red pixels (R), green pixels (G) and blue pixels (B), which are arranged on the same plane of support substrate (1) shown in FIG. 1, in a stripe pattern (see FIG. 2) or a mosaic (or lattice) pattern (see FIG. 3).

The color filter is required to have properties to select transmitting light such that it allows only light having the wavelength of the specific color of the respective pixel to pass, while it shields visible light having other wavelength. In addition, the pattern pixels of the color filter should have a sufficient color strength.

With the miniaturization and the increase of definition of CCD, it is desired for a color filter to have finer pattern pixels. That is, when the size of each pixel of the color filter is decreased, CCD on which the color filter is mounted can be miniaturized, and the number of pixels is increased so that image information with a high resolution can be obtained.

As the size of the pixel of the color filter is decreased, the reduction of a thickness of the color filter is desired. With the color filter having a small thickness, incident light which reaches CCD from an oblique direction can reach the photosensitive part of CCD, which is present under the color filter, and thus a numerical aperture can be increased. That is, the incident light from an oblique direction can pass through the color filter and then reach the photosensitive part of CCD.

For the production of such a color filter, a method for producing a color filter by photolithography using a colored photosensitive composition containing a colorant such as a pigment or a dye for example, a photoresist (cf. JP-A-2-127602, JP-A-4-283701 and JP-2002-14220 A). Such a method produces a color filter consisting of an agglomerate of a plurality of minute pixels each of which is respectively colored with one of the three primary colors (red, green and blue).

However, a color filter formed of a conventional colored photosensitive composition has a large thickness. Therefore, when each pattern region constituting the color filter is made small, the incident light cannot be sufficiently utilized and thus a clear image may not be recorded. For this reason, a color filter having a sufficient optical density cannot be produced, when a color filter having a thickness of 1.5 μm or less is produced using the conventional colored photosensitive composition.

When a concentration of a dye is increased in a conventional positive type colored photosensitive composition comprising a dye to achieve a sufficient optical density in a color filter having a thickness of 1.5 μm or less, a pattern is dissolved in a developing step after the projection and exposure of the color filter so that a pattern cannot be formed.

Due to the dissolution of the pattern, the color filter formed cannot achieve a desired optical density and the color strength becomes less uniform in the pixels. Therefore, an image inputted from CCD has color unevenness or the color reproduction of the image data is deteriorated. In particular, in the case of the formation of a red color filter, a red dye has a smaller molecular extinction coefficient than green and blue dyes, and thus it is difficult for the red color filter to have a sufficient optical density, and also to achieve a good balance of the red, green and blue colors.

### SUMMARY OF THE INVENTION

One object of the present invention is to provide a red-colored photosensitive composition, which has good properties to select transmitting light, can form a pattern with a small exposing intensity, and has a good residual rate of film after development and good solvent resistance, and also to provide a color filter produced using such a red-colored photosensitive composition. Furthermore, the present invention provides a solid state image pickup device comprising such a color filter.

Accordingly, the present invention provides a positive type red-colored photosensitive composition comprising a colorant, a photo active compound, a curing agent, a solvent and optionally an alkali-soluble resin, wherein the contents of the dye, photo active compound, curing agent and optional alkali-soluble resin are from 55 to 63 parts by weight, from 10 to 30 parts by weight, 10 to 25 parts by weight and 1 parts by weight or less, respectively, per 100 parts by weight of solid components of the photosensitive composition.

The present invention further provides a color filter comprising pixels which are formed using the above positive type red-colored photosensitive composition of the present invention, and also a solid state image pickup device comprising the color filter of the present invention.

When the positive type red-colored photosensitive composition of the present invention is used, a pattern can be formed using a color filter having a thickness of 1.5 μm or less or when a low exposing intensity is used. Furthermore, the color unevenness of an image can be minimized, since pattern film reduction is small in the developing step and the film has good solvent resistance. The color filter of the present invention is preferably used in a solid state image pickup device comprising CCD. In particular, when a preferable dye described herein is used, a color filter having red pixels, which has good properties to select light having a wavelength in a red region, can be produced.

### BRIEF DESCRIPTION OF THE DRAWINGS

FIG. 1 is a schematic cross section of a color filter on which the pixels of red, green and blue are formed.

FIG. 2 is a schematic plan view of a color filter on which the pixels of red, green and blue are formed in a stripe pattern.

FIG. 3 is a schematic plan view of a color filter on which the pixels of red, green and blue are formed in a mosaic pattern.

FIG. 4 is a schematic cross section of a solid state image pickup device having a color filter formed on a photoreceptor.

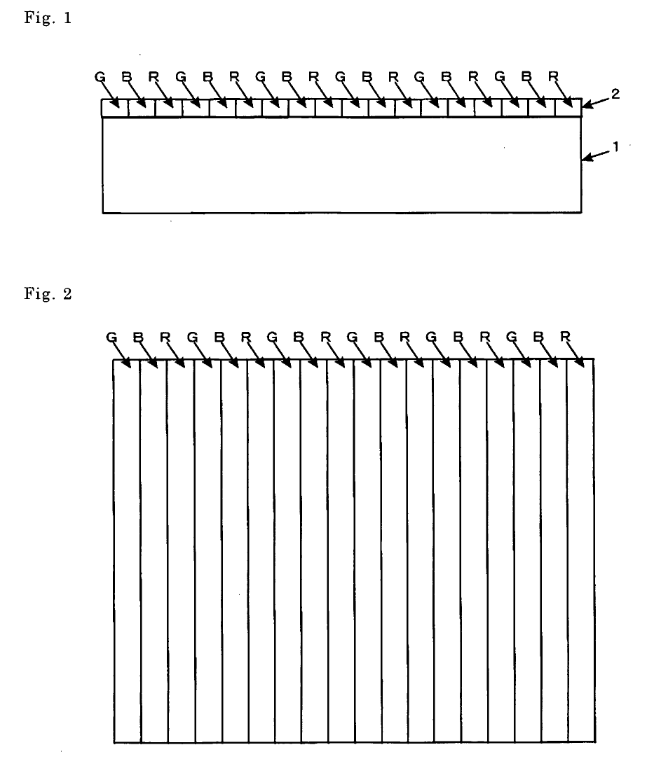

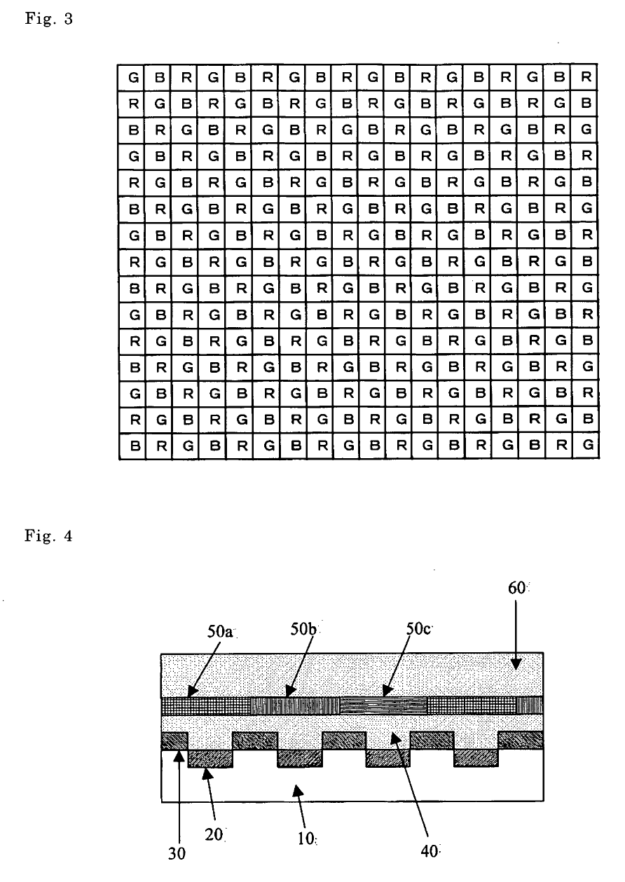

### DETAILED DESCRIPTION OF THE INVENTION

A preferable example of a dye used in the present invention is a dye of the formula (IV):

D(SO₂NHR¹)ₙ (IV)

wherein D is a basic residue of a dye selected from the group consisting of xanthene compound, azo compound (pyrazolone azo compound etc.) and anthraquinone compound; n is an integer of 1 to 4; R¹ represents an aliphatic hydrocarbon group having 3 to 20 carbon atoms, a cyclohexyl group, an alkylcyclohexyl group having 1 to 4 carbon atoms in the alkyl group, an aliphatic 1 alkoxyalkyl group having 3 to 24 carbon atoms which is substituted with an alkoxyl group having 1 to 12 carbon atoms, an aliphatic ester group having 3 to 24 carbon atoms or an arylalkyl group having 7 to 20 carbon atoms, preferably an arylalkyl group having 7 to 20 carbon atoms having an aryl group selected from a phenyl group and a naphthyl group which may have a substituent, provided that when n is an integer of 2 to 4, substituents R¹ may be the same or different.

Specific examples of the aliphatic hydrocarbon group include propyl, hexyl, octyl, decyl, 1-methylbutyl, 1,1,3,3-tetramethylbutyl, 1,5-dimethylhexyl, 1,6-dimethylheptyl, 2-ethylhexyl and 1,1,5,5-tetramethylhexyl. Specific examples of the alkylcyclohexyl group include 2-methylcyclohexyl and 2-ethylcyclohexyl. Specific examples of the aliphatic alkoxyalkyl group include ethoxypropyl, isopropoxypropyl, octyloxypropyl, 3-ethoxy-n-propyl and 3-(2-ethylhexyloxy)propyl. Specific examples of the aliphatic ester group include propoxycarbonylpropyl, ethoxycarbonylbutyl, propionyloxyethyl and butyryloxybutyl. Specific examples of the arylalkyl group include benzyl, phenethyl and 1-methyl-3-phenylpropyl.

Among the dyes of the formula (IV), a particularly preferable dye is a compound of the formula (I) or its salt:

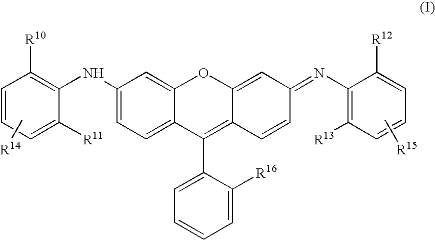

wherein

R¹⁰ to R¹³ represent independently each other a hydrogen atom or an alkyl group having 1 to 3 carbon atoms; and

R¹⁴ to R¹⁶ represent independently each other a sulfonic acid group or a substituent of the formula (I-1), provided that at least one of R¹⁴ to R¹⁶ is a substituent of the formula (I-1):

—SO₂NHR¹⁷ (I-1)

where R¹⁷ is an alkyl group having 2 to 20 carbon atoms, a cyclohexylalkyl group having 2 to 12 carbon atoms in the alkyl group, an alkylcyclohexyl group having 1 to 4 carbon atoms in the alkyl group, an alkyl group having 2 to 12 carbon atoms which is substituted with at least one alkoxyl group having 2 to 12 carbon atoms, an alkylcarboxyalkyl group of the formula (I-1-1):

L¹—CO—O—L²— (I-1-1)

in which L¹ is an alkyl group having 2 to 12 carbon atoms, and L² is an alkylene group having 2 to 12 carbon atoms, an alkyloxycarbonylalkyl group of the formula (I-1-2):

L³—O—CO—L⁴— (I-1-2)

in which L³ is an alkyl group having 2 to 12 carbon atoms, and L⁴ is an alkylene group having 2 to 12 carbon atoms, a phenyl group substituted with at least one alkyl group having 1 to 20 carbon atoms, or an alkyl group having 1 to 20 carbon atoms substituted with at least one phenyl group.

In the compound of the formula (I) or its salt (hereinafter referred to as “Dye (I)”), examples of the alkyl group having 1 to 3 carbon atoms for R¹⁰ to R¹³ include methyl, ethyl, n-propyl, isopropyl, etc.

Examples of the alkyl group having 2 to 20 carbon atoms for R¹⁷ include ethyl, n-propyl, isopropyl, n-hexyl, n-nonyl, n-decyl, n-dodecyl, 2-ethylhexyl, 1,3-dimethylbutyl, 1-methylbutyl, 1,5-dimethylhexyl, 1,1,3,3-tetrametylbutyl, etc.

Examples of the cyclohexylalkyl group having 2 to 12 carbon atoms in the alkyl group include cyclohexylethyl, 3-cyclohexylpropyl, 8-cyclohexyloctyl, etc.

Examples of the alkylcyclohexyl group having 1 to 4 carbon atoms in the alkyl group include 2-ethylcyclohexyl, 2-propylcyclohexyl, 2-n-butylcyclohexyl, etc.

Examples of the alkyl group having 2 to 12 carbon atoms which is substituted with at least one alkoxyl group having 2 to 12 carbon atoms include 3-ethoxy-n-propyl, propoxypropyl, 4-propoxy-n-butyl, 3-methyl-n-hexyloxyethyl, 3-(2-ethylhexyloxy)propyl, etc.

Examples of the phenyl group substituted with at least one alkyl group having 1 to 20 carbon atoms include o-isopropylphenyl, etc.

Examples of the alkyl group having 1 to 20 carbon atoms substituted with at least one phenyl group include DL-1-phenylethyl, benzyl, 3-phenyl-n-butyl, etc.

Examples of the alkyl group having 2 to 20 carbon atoms for L¹ and L² include ethyl, propyl, n-hexyl, n-nonyl, n-decyl, n-dodecyl, 2-ethylhexyl, 1,3-dimethylbutyl, 1-methylbutyl, 1,5-dimethylhexyl, 1,1,3,3-tetrametylbutyl, etc.

Examples of the alkylene group having 2 to 12 carbon atoms for L² and L⁴ include dimethylene, hexamethylene, etc.

Dye (I) may be a compound of the formula (I) or its salt. Examples of such a salt include salts substituted with an alkali metal such as lithium, sodium, potassium, etc. When at least one of R¹⁴, R¹⁵ and R¹⁶ is a sulfonic acid group, a salt may be a sulfonate salt.

A preferred example of the dye of the formula (I) is a compound of the formula (10):

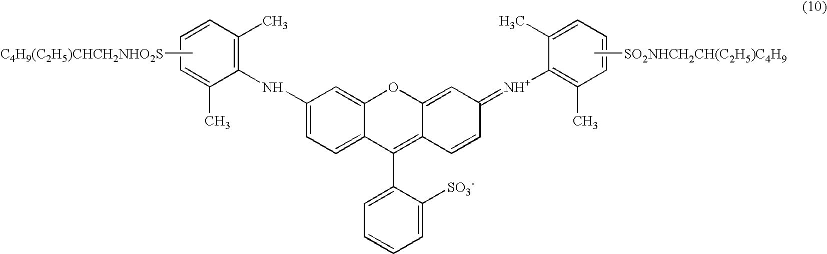

The compound of the formula (10) is described in JP-A-6-230210, JP-A-7-242651, etc.

Apart from the compound of the formula (I), preferred dyes used in the colored photosensitive composition of the present invention are a compound of the formula (II) or its salt, and a compound of the formula (III) or its salt:

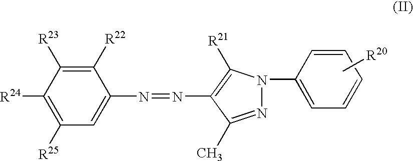

wherein R²¹ and R²² represent independently each other a hydroxyl group or a carboxyl group, and R²⁰, R²³, R²⁴ and R²⁵ represent independently each other a hydrogen atom, a halogen atom, an alkyl group having 1 to 4 carbon atoms, a sulfonic acid group or a nitro group.

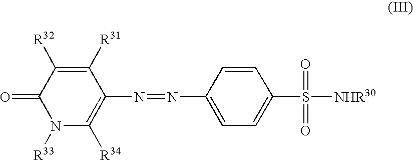

wherein R³⁰ represents an alkyl group having 2 to 10 carbon atoms, R³¹, R³² and R³⁴ represent independently each other a hydrogen atom, a methyl group, a hydroxyl group or a cyano group, and R³³ represents an alkyl group having 1 to 4 carbon atoms.

In the compound of the formula (II) or its salt (hereinafter referred to “Dye (II)”), examples of the halogen atom for R²⁰, R²³, R²⁴ and R²⁵ are a fluorine atom, a chlorine atom, a bromine atom, etc. Examples of the alkyl group having 1 to 4 carbon atoms include methyl, ethyl, propyl, butyl, etc., and examples of the alkoxyl group having 1 to 4 carbon atoms include methoxy, ethoxy, propoxyl, butoxy, etc.

Dye (II) may be a compound of the formula or its salt. Examples of such a salt is a salt with an alkali metal such as lithium, sodium, potassium, etc. or their mixture. When at least one of R²³ to R²⁶ is a sulfonic acid group, a salt may be a sulfonate salt.

Dye (II) may form a complex coordinated with a metal atom. The metal complex of Dye (II) has improved light resistance. Examples of the metal atom are transition metal atoms, in particular, chromium atom.

Among the dyes of the formula (II), C.I. Solvent Yellow 82, C.I. Solvent Orange 56, etc. are preferable.

In the compound of the formula (III) or its salt (hereinafter referred to “Dye (III)”), examples of the alkyl group having 2 to 10 carbon atoms for R³⁰ include ethyl, propyl, n-hexyl, n-nonyl, n-decyl, n-dodecyl, 2-ethylhexyl, 1,3-dimethylbutyl, 1-methylbutyl, 1,5-dimethylhexyl, 1,1,3,3-tetrametylbutyl, etc.

Examples of the alkyl group having 1 to 4 carbon atoms for R³³ include methyl, ethyl, propyl, butyl, etc.

The compound of the formula (III) may be prepared by a method described in, for example, JP-A-50-28530.

Among the dyes of the formula (III), C.I. Solvent Yellow 162, etc. are preferable.

Dyes which can be used in addition to the dye of the formula (IV) may be acid dyes and their amide derivatives, oil-soluble dyes, etc.

In particular, examples of combinations of dyes used to form red pixels include Compound (10)/C.I. Solvent Yellow 162, Compound (10)/C.I. Solvent Yellow 162/C.I. Solvent Yellow 82, Compound (10)/C.I. Solvent Yellow 162/C.I. Solvent Orange 56, Compound (10)/C.I. Solvent Yellow 162/C.I. Solvent Yellow 82/C.I. Solvent Orange 56, etc. Among them, the combination of Compound (10)/C.I. Solvent Yellow 162/C.I. Solvent Yellow 82 is preferable.

The contents of the dyes in the red-colored photosensitive composition of the present invention are preferably 25 to 40 parts by weight of Dye (I), 25 to 40 parts by weight of Dye (II) and 25 to 40 parts by weight of Dye (III), more preferably 35 to 40 parts by weight of Dye (I), 30 to 35 parts by weight of Dye (II) and 30 to 35 parts by weight of Dye (III), per 100 parts by weight of the dyes. When the dyes are contained in the above ranges, the color filter has a sufficient optical density. Furthermore, residues of the photosensitive resin composition do not remain in the dissolved parts in the developing step, when the red pixel pattern of the color filter is formed using the positive red-colored photosensitive composition.

The total amount of the dye or dyes contained in the photosensitive composition is usually from 55 to 63 parts by weight, preferably from 59 to 63 parts by weight, per 100 parts by weight of the solid components of the positive type red-colored photosensitive composition. When the amount of the dye or dyes is less than 55 parts by weight, the optical density tends to be insufficient when a thin film is formed. When the amount of the dye or dyes exceeds 63 parts by weight, the pattern is dissolved in the developing step, and the pattern may have serious defects in the color filter produced.

In the present invention, all the solid components of the resin composition mean total of dyes, photo active compounds, curing agents and alkali-soluble resins.

As the photo active compound contained in the positive type colored photosensitive composition of the present invention, esters of phenol compounds and o-naphthoquinonediazidosulfonic acid compounds, and the like can be used. Examples of the phenol compounds include di-, tri-, tetra- and pentahydroxybenzophenone, and a compound of the following formula (11), etc., and examples of the o-naphthoquinonediazidosulfonic acid compounds include o-naphthoquinonediazido-5-sulfonic acid, o-naphthoquinonediazido-4-sulfonic acid, etc.

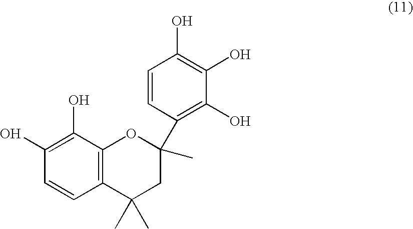

The curing agent contained in the positive type red-colored photosensitive composition of the present invention may be a hot curing agent which cures the resin by heating. A typical example of the hot curing agent is a compound of the formula (12):

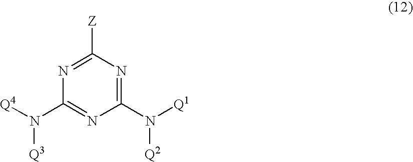

wherein Q¹ to Q⁴ represent independently each other a hydrogen atom, a hydroxyalkyl group having 1 to 4 carbon atoms, or an alkyl group having 1 to 4 carbon atoms which is substituted with at least one alkoxyl group having 1 to 4 carbon atoms. Z is a phenyl group or a substituent of the formula (13):

Q⁵Q⁶N— (13)

in which Q⁵ and Q⁶ represent independently each other a hydrogen atom, a hydroxyalkyl group having 1 to 4 carbon atoms, or an alkyl group having 1 to 4 carbon atoms which is substituted with at least one alkoxyl group having 1 to 4 carbon atoms, provided that at least one of Q¹ to Q⁶ is a hydroxyalkyl group having 1 to 4 carbon atoms or an alkyl group having 1 to 4 carbon atoms which is substituted with at least one alkoxyl group having 1 to 4 carbon atoms.

Examples of the hydroxyalkyl group having 1 to 4 carbon atoms include hydroxymethyl, hydroxyethyl, hydroxypropyl, hydroxybutyl, etc., and examples of the alkyl group having 1 to 4 carbon atoms which is substituted with at least one alkoxyl group having 1 to 4 carbon atoms include methoxyymethyl, methoxyethyl, ethoxyethyl, propoxybutyl, etc.

Typical examples of the compound of the formula (13) include hexamethoxymethylmelamine, etc.

The positive type red-colored photosensitive composition of the present invention may contain an alkali-soluble resin such as a novolak resin, a polyvinyl resin, etc.

Examples of the novolak resin include a p-cresol novolak resin, a m-cresol novolak resin, a p-cresol-m-cresol novolak resin, and a novolak resin having a structure of the formula (14):

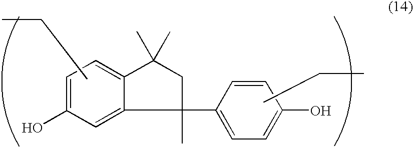

Examples of the polyvinyl resin include a poly-p-vinylphenol, a copolymer of styrene and p-vinylphenol, etc.

Such an alkali-soluble resin has a polystyrene-converted weight average molecular weight of 3,000 to 14,000, preferably 5,500 to 13,500.

Preferably, the positive type red-colored photosensitive composition of the present invention comprises 55 to 63 parts by weight of the dye, 1 parts by weight or less of the alkali-soluble resin, 10 to 30 parts by weight of the photo active compound, and 10 to 25 parts by weight of the curing agent, per 100 parts by weight of the solid components of the photosensitive composition.

When the amount of the dye is less than 55 parts by weight, the color filter has pale colors, so that it may lose the functions as a color filter. When the amount of the dye exceeds 63 parts by weight, the film reduction of the color filter occurs in the developing step in the process of the pattern formation so that the color filter has color unevenness.

When the amount of the photo active compound is in the range of 10 to 30 parts by weight, the film reduction of the color filter does not occur in the developing step and thus the image rarely has color unevenness. Furthermore, a production efficiency of the color filter is not deteriorated since the projection and exposing time for sensitizing all the photosensitizer is not prolonged in the pattern forming process.

When the amount of the curing agent is in the range of 10 to 25 parts by weight, the color filter pattern has sufficient mechanical properties when it is thermally cured. Furthermore, the film reduction of the color filter hardly occurs in the developing step and thus the image rarely has color unevenness.

When the amount of the alkali-soluble resin is 1 parts by weight or less, the photosensitive composition has a sufficient solubility in an alkaline developer so that the good pattern can be formed. Furthermore, the film reduction of the color filter hardly occurs in the developing step and thus the image rarely has color unevenness.

The amounts (parts by weight) of the photo active compound, curing agent and alkali-soluble resins may be suitably selected from the above ranges depending of the projection exposed amount of the pixel pattern, the film reduction of the pixel pattern in the development, the mechanical strength of the pixel pattern, and so on.

The positive type red-colored photosensitive composition of the present invention may contain a solvent. The kind of the solvent is selected depending on the solubilities of the components of the photosensitive composition, that is, the dye, photo active compound, alkali-soluble resin and curing agent, in particular, the solubility of the dye.

Specific examples of the solvent include methyl cellosolve, ethyl cellosolve, methyl cellosolve acetate, ethyl cellosolve acetate, diethylene glycol dimethyl ether, ethylene glycol monoisopropyl ether, propylene glycol monomethyl ether, propylene glyclol monomethyl ether acetate, N-methylpyrrolidone, γ-butyrolactone, dimethylsulfoxide, N,N-dimethylformamide, cyclohexane, ethyl acetate, n-butyl acetate, ethyl pyruvate, ethyl lactate, etc. These solvents may be used independently or as a mixture of two or more.

The amount of the solvent contained in the colored photosensitive composition of the present invention is usually from 230 to 400 parts by weight, preferably from 250 to 300 parts by weight, per 100 parts by weight of the solid components of the photosensitive composition. When the amount of the solvent is from 230 to 400 parts by weight, the coating unevenness may be decreased when the thin film is formed on a substrate using the positive type red-colored photosensitive composition of the present invention.

When the positive type red-colored photosensitive composition of the present invention is used, a color filter comprising a pattern red pixels having a thickness of 1.5 μm or less, and a width and a length of each 2 to 20 μm can be produced.

The color filter can be formed by a photolithography method as in the case of conventional colored photosensitive compositions. For example, a coating layer of the colored photosensitive composition of the present invention is formed on a surface of a support, and then the coating layer is exposed to light through a mask and developed to form a pattern. As a support, a silicon wafer on which CCD is formed, a transparent glass plate, a quartz plate, etc. can be used.

To form the coating layer, the positive type red-colored photosensitive composition of the present invention is coated on a support by a conventional coating method such as spin coating, dip coating, cast coating, roll coating, slit-and-spin coating, and the like. After coating, the support carrying the coating layer may be heated to evaporate the volatile components such as a solvent. Thereby, a layer of the solid components of the colored photosensitive composition is formed on the substrate.

Thereafter, the coated film is exposed to light. To this exposure, a masking pattern having a pattern corresponding to an intended pattern to be formed is used, and the light beam is irradiated to the coated film through the masking pattern. As a light source, g-line, i-line, etc. can be used. In concrete, an exposing apparatus such as a g-line stepper, an i-line stepper, etc. can be used. The irradiation amount of light is selected depending on the kind and content of the photo active compound, the kind and content of the curing agent, the polystyrene-converted weight average molecular weight, monomer composition and content of the alkali-soluble resin, etc. After exposure, the coated film may optionally be heated. The heating will improve a contrast of the photo active compound in the film. When the coated film is heated, a temperature is from 80 to 150° C.

After exposure, the coated film is developed. The coated film can be developed by dipping the support carrying the coated film thereon in a developer in the same way as in the case of the conventional positive type colored photosensitive composition being used. As a developer, the same developer as one used to form a pattern with the conventional colored photosensitive composition may be used. After dipping, the support is pulled out from the developer and washed with water to remove the developer. Thereby, a color filter comprising red pixels formed in a desired pattern is obtained. Alternatively, the support may be pulled out from the developer, rinsed with a rinsing liquid, and then washed with water. The rinsing can remove the residue of the colored photosensitive composition remaining on the support after development.

The pattern may be irradiated with UV ray. The irradiation with UV ray can decompose the remaining photo active compound in the pixels formed. After washing with water, the support is heated to improve the mechanical strength of the color filter pattern.

The heating temperature is from 160° C. to 220° C. In this heating temperature range, the photosensitive composition is sufficiently cured with the curing agent, while the dye is not decomposed.

As described above, the red pixels of the color filter with the desired pattern is formed. When the above steps for forming the pattern of the color filter are repeated with each color, the pixels of three colors, that is, the pixels of red, green and blue, are formed on the same plane of the support. The order of the formation of the pixels of the respective colors is arbitrary.

A solid state image pickup device comprising such a color filter may be produced by a conventional method. For example, a solid state image pickup device having a color filter on a photoreceptor, the cross section of which is shown in FIG. 4, is produced as follows:

Firstly, photoreceptors 20 are formed on the surface of a silicon wafer and then transfer electrodes 30, which transfer electrons from the photoreceptor, are formed on the surface of the silicon waver to produce a substrate of a solid state image pickup device, that is, a substrate having photoreceptors 20 and transfer electrodes 30 thereon. Before forming a color filter on the substrate, flat film-forming layer 40 is formed on the surface of the substrate. Thereafter, the colored photosensitive composition of the present invention is applied on the surface of flat film-forming layer 40 formed on the substrate, a pattern is projected, exposed and developed, followed by thermal curing to form a color filter of color pixels 50a. Thereafter, the above steps are repeated using a colored photosensitive composition comprising a dye of other color to form color filters of color pixels 50b and 50c. Finally, protective film 60 is formed to protect the surface of the color filters.

The preferred embodiments of the present invention have been explained by way of examples, but they do not limit the scope of the present invention. The scope of the present invention should be determined only by the claims appended hereto, and includes variations and modifications thereto.

### EXAMPLES

Hereinafter, the present invention will be illustrated by the following examples, which do not limit the scope of the present invention in any way.

In the Examples, “parts” are “parts by weight”.

### Example 1

A positive type red-colored photosensitive composition was prepared by mixing 2.2 parts of a compound of the formula (10):

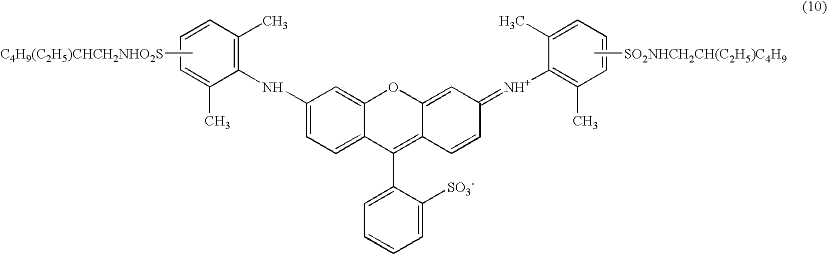

as a dye, 2.1 parts of C.I. Solvent Orange 56 as a dye, 1.6 parts of C.I. Solvent Yellow 162 as a dye, 2.6 parts of the ester of a phenol compound of the formula (11) with o-naphthoxydiazido-5-sulfonic acid as a photo active compound, 1.6 parts of hexamethoxymethylmelamine as a curing agent, 20.0 parts of ethyl lactate and 9.0 parts of N,N-dimethylformamide as solvents, and filtrating the mixture with a membrane filer having a pore size of 0.1 μm.

SUMIRESIST PR-1300Y-PG (manufactured by Sumitomo Chemical Co., Ltd.) as a flat film-forming agent was spin coated on a silicon wafer and heated at 100° C. for 1 minute to remove volatile materials to form a coating film having a thickness of 0.5 μm. Then, the wafer was heated at 230° C. for 15 minutes to cure the coating film. Thereby, a support was obtained. On this support, the positive type red-colored photosensitive composition prepared in the above step was spin coated and heated at 100° C. for 1 minute to remove volatile materials to form a coating film. Thereafter, the coating film of the photosensitive composition was irradiated with i-line through a masking pattern using a wafer stepper (Nikon NSR i7A manufactured by Nikon Corporation) at an exposing intensity of 1,300 mJ. After exposure, the wafer was dipped in a developer (SOPD manufactured by Sumitomo Chemical Co., Ltd.) at 23° C. for 30 seconds to develop the exposed coating layer. After development, the wafer was rinsed with a rinse liquid (1.9 wt. % aqueous solution of tetramethylammonium hydroxide containing 0.15% by weight of polyoxyethylene nonylphenyl ether), washed with water, dried, irradiated with UV ray and then heated at 180° C. for 3 minutes to obtain a color filter having red pixels which were formed in a stripe pattern having a line width of 3.0 μm and a thickness of 1.1 μm.

A color filter having red pixels which were formed in a mosaic pattern having a line width of 3.0 μm and a thickness of 1.1 μm was produced in the same manner as above except that a masking pattern was changed.

Furthermore, a color filter having red pixels, which were formed all aver the surface of a support and had a thickness of 1.1 μm, was produced in the same manner as above except that a glass plate was used as a support and the coating film of the photosensitive composition was developed without exposure.

### Comparative Example 1

A positive type red-colored photosensitive composition was prepared by mixing 2.4 parts of a compound of the formula (10):

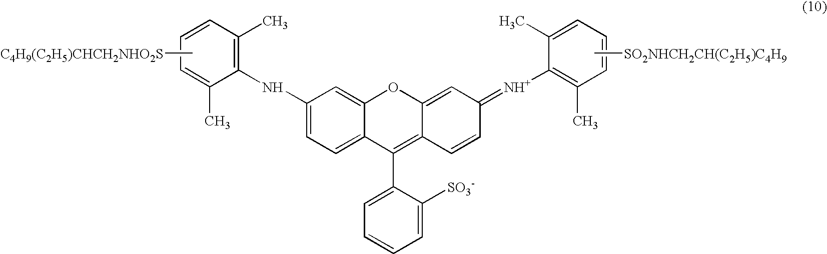

2.2 parts of C.I. Solvent Orange 56 and 2.0 parts of C.I. Solvent Yellow 162 as dyes, 1.5 parts of the ester of a phenol compound of the formula (11) with o-naphthoxydiazido-5-sulfonic acid as a photo active compound, 0.4 part of a novolak resin having the structure of the formula (14):

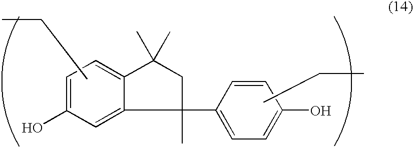

(polystyrene-converted weight average molecular weight: 13,500) as an alkali-soluble resin, 1.6 parts of hexamethoxymethylmelamine as a curing agent, 23.0 parts of ethyl lactate and 10.0 parts of N,N-dimethylformamide as solvents, and filtrating the mixture with a membrane filer having a pore size of 0.1 μm.

SUMIRESIST PR-1300Y-PG (manufactured by Sumitomo Chemical Co., Ltd.) as a flat film-forming agent was spin coated on a silicon wafer and heated at 100° C. for 1 minute to remove volatile materials to form a coating film having a thickness of 0.5 μm. Then, the wafer was heated at 230° C. for 15 minutes to cure the coating film. Thereby, a support was obtained. On this support, the positive type red-colored photosensitive composition prepared in the above step was spin coated and heated at 100° C. for 1 minute to remove volatile materials to form a coating film. Thereafter, the coating film of the photosensitive composition was irradiated with i-line through a masking pattern using a wafer stepper (Nikon NSR i7A manufactured by Nikon Corporation) at an exposing intensity of 1,300 mJ. After exposure, the wafer was dipped in a developer (SOPD manufactured by Sumitomo Chemical Co., Ltd.) at 23° C. for 30 seconds to develop the exposed coating layer. After development, the wafer was rinsed with a rinse liquid (1.9 wt. % aqueous solution of TMAH containing 0.15% by weight of polyoxyethylene nonylphenyl ether), washed with water, dried, irradiated with UV ray and then heated at 180° C. for 3 minutes to obtain a color filter having red pixels which were formed in a stripe pattern having a line width of 3.0 μm and a thickness of 1.0 μm.

A color filter having red pixels which were formed in a mosaic pattern having a line width of 3.0 μm and a thickness of 1.0 μm was produced in the same manner as above except that a masking pattern was changed.

Furthermore, a color filter having red pixels, which were formed all aver the surface of a support and had a thickness of 1.0 μm, was produced in the same manner as above except that a glass plate was used as a support and the coating film of the photosensitive composition was developed without exposure.

### Comparative Example 2

A positive type red-colored photosensitive composition was prepared by mixing 1-4 parts of a compound of the formula (10):

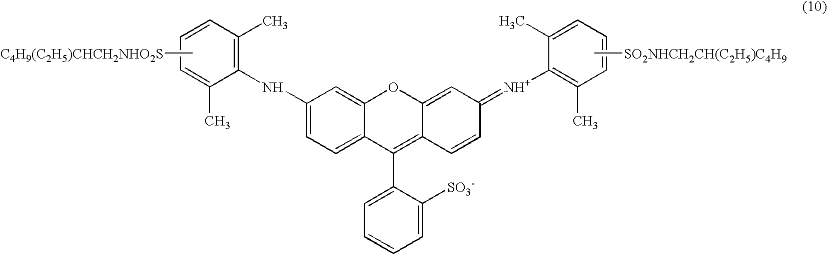

0.9 part of C.I. Solvent Orange 56, 0.8 part of C.I. Solvent Yellow 82 and 0.8 part of C.I. Solvent Yellow 162 as dyes, 3.3 parts of the ester of a phenol compound of the formula (11) with o-naphthoxydiazido-5-sulfonic acid as a photo active compound, 0.5 part of a novolak resin having the structure of the formula (14):

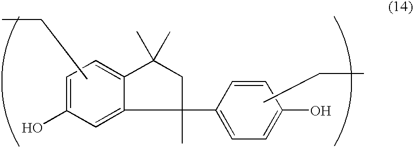

(polystyrene-converted weight average molecular weight: 13,500) as an alkali-soluble resin, 2.3 parts of hexamethoxymethylmelamine as a curing agent, 16.3 parts of ethyl lactate and 7.0 parts of N,N-dimethylformamide as solvents, and filtrating the mixture with a membrane filer having a pore size of 0.1 μm.

SUMIRESIST PR-1300Y-PG (manufactured by Sumitomo Chemical Co., Ltd.) as a flat film-forming agent was spin coated on a silicon wafer and heated at 100° C. for 1 minute to remove volatile materials to form a coating film having a thickness of 0.5 μm. Then, the wafer was heated at 230° C. for 15 minutes to cure the coating film. Thereby, a support was obtained. On this support, the positive type red-colored photosensitive composition prepared in the above step was spin coated and heated at 100° C. for 1 minute to remove volatile materials to form a coating film. Thereafter, the coating film of the photosensitive composition was irradiated with i-line through a masking pattern using a wafer stepper (Nikon NSR i7A manufactured by Nikon Corporation) at an exposing intensity of 1,300 mJ. After exposure, the wafer was dipped in a developer (SOPD manufactured by Sumitomo Chemical Co., Ltd.) at 23° C. for 30 seconds to develop the exposed coating layer. After development, the wafer was rinsed with a rinse liquid (1.9 wt. % aqueous solution of TMAH containing 0.15% by weight of polyoxyethylene nonylphenyl ether), washed with water, dried, irradiated with UV ray and then heated at 180° C. for 3 minutes to obtain a color filter having red pixels which were formed in a stripe pattern having a line width of 3.0 μm and a thickness of 1.3 μm.

A color filter having red pixels which were formed in a mosaic pattern having a line width of 3.0 μm and a thickness of 1.3 μm was produced in the same manner as above except that a masking pattern was changed.

Furthermore, a color filter having red pixels, which were formed all aver the surface of a support and had a thickness of 1.0 μm, was produced in the same manner as above except that a glass plate was used as a support and the coating film of the photosensitive composition was developed without exposure.

Evaluations of Color Filters

(1) Selectivity of Transmitting Light

With the color filter having pixels of the respective color all over the surface of the glass substrate, a light transmittance was measured at a wavelength of 450 nm, 540 nm and 650 nm. The results are shown in Table 1.

(2) Pattern Projection Exposing Intensity

In Example 1 and Comparative Examples 1-2, a line-and-space pattern of 3.0 μm was formed with varying an exposing intensity, and an exposing intensity was measured when the line width reached 3.0 μm. The results are shown in Table 2.

(3) Residual Rate of Film in Development

With the color filters produced in Example 1 and Comparative Examples 1-2, the film thickness of the pixels, which were formed using the positive type colored photosensitive compositions, was measured before and after the development with an alkali developer in the process of forming the color filter pattern. The results are shown in Table 3.

(4) Solvent Resistance

The positive type red-colored photosensitive composition prepared in each of Example 1 and Comparative Examples 1-2 was coated on the entire surface of a silicone wafer, irradiated with UV ray and then heated at 180° C. for 3 minutes to cure the photosensitive composition. The silicon waver having the coated film of the photosensitive composition thereon was dipped in a mixed solvent of 70% by weight of ethyl lactate and 30% by weight of N,N-dimethylformamide, which was used as a solvent of the positive type red-colored photosensitive composition, for 3 minutes. The change of the film thickness between before and after dipping was measured.

TABLE 1

| | | Light transmittance*¹⁾ (%) | | |
|---|---|---|---|---|
| Example | Film thickness | at a wavelength of | | |
| No. | (μm) | 450 nm | 540 nm | 650 nm |
| Ex. 1 | 1.10 | 0.9 | 0.4 | 97.0 |
| C. Ex. 1 | 1.00 | 1.5 | 0.8 | 97.5 |
| C. Ex. 2 | 1.30 | 4.7 | 2.7 | 94.4 |

Note:
*¹⁾As converted to a value per 1 μm film thickness.

TABLE 2

| Example | Exposing intensity |
|---|---|
| No. | (mJ) |
| Ex. 1 | 1,500 |
| C. Ex. 1 | 1,200 |
| C. Ex. 2 | 2,650 |

TABLE 3

| Example | Film thickness (μm) | | Residual rate |
|---|---|---|---|
| No. | before development | after development | of film*¹ (%) |
| Ex. 1 | 1.10 | 1.07 | 97.3 |
| C. Ex. 1 | 1.00 | 0.92 | 92.0 |
| C. Ex. 2 | 1.30 | 1.28 | 98.5 |

*¹Residual rate of film = [(film thickness after development)/(film thickness before development)] × 100

TABLE 4

| | | |
|---|---|---|
| Example | Film thickness (μm) | Residual rate |

| No. | before dipping | after dipping | of film*¹ (%) |
|---|---|---|---|
| Ex. 1 | 1.10 | 1.10 | 100 |
| C. Ex. 1 | 1.00 | 0.98 | 98 |
| C. Ex. 2 | 1.30 | 1.30 | 100 |

*¹Residual rate of film = [(film thickness after dipping)/(film thickness before development)] × 100

What is claimed is:

1. A positive type red-colored photosensitive composition comprising a colorant, a photo active compound, a curing agent, a solvent and optionally an alkali-soluble resin, wherein the contents of the dye, photo active compound, curing agent and optional alkali-soluble resin are from 55 to 63 parts by weight, from 10 to 30 parts by weight, 10 to 25 parts by weight and 1 parts by weight or less, respectively, per 100 parts by weight of solid components of the photosensitive composition.

2. The positive type red-colored photosensitive composition according to claim 1, which contains no alkali-soluble resin.

3. The positive type red-colored photosensitive composition according to claim 1 or 2, wherein said dye is a dye of the formula (IV) or its salt:
D(SO₂NHR¹)ₙ (IV)
wherein D is a basic residue of a dye selected from the group consisting of xanthene compound, azo compound and anthraquinone compound; n is an integer of 1 to 4; R¹ represents an aliphatic hydrocarbon group having 3 to 20 carbon atoms, a cyclohexyl group, an alkylcyclohexyl group having 1 to 4 carbon atoms in the alkyl group, an aliphatic alkoxyalkyl group having 3 to 24 carbon atoms which is substituted with an alkoxyl group having 1 to 12 carbon atoms, an aliphatic ester group having 3 to 24 carbon atoms or an aryalkyl group having 7 to 20 carbon atoms, preferably an arylalkyl group having 7 to 20 carbon atoms having an aryl group selected from a phenyl group and a naphthyl group which may have a substituent, provided that when n is an integer of 2 to 4, substituents R¹ may be the same or different.

4. The positive type red-colored photosensitive composition according to claim 1 or 2, wherein said dye is a dye of the formula (I) or its salt: 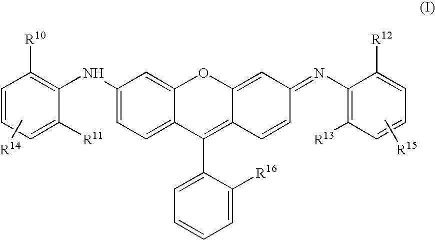
wherein
R¹⁰ to R¹³ represent independently each other a hydrogen atom or an alkyl group having 1 to 3 carbon atoms; and
R¹⁴ to R¹⁶ represent independently each other a sulfonic acid group or a substituent of the formula (I-1), provided that at least one of R¹⁴ to R¹⁶ is a substituent of the formula (I-1):
—SO₂NHR¹⁷ (I-1)
where R¹⁷ is an alkyl group having 2 to 20 carbon atoms, a cyclohexylalkyl group having 2 to 12 carbon atoms in the alkyl group, an alkylcyclohexyl group having 1 to 4 carbon atoms in the alkyl group, an alkyl group having 2 to 12 carbon atoms which is substituted with at least one alkoxyl group having 2 to 12 carbon atoms, an alkylcarboxyalkyl group of the formula (I-1-1):
L¹—CO—O—L²— (I-1-1)
in which L¹ is an alkyl group having 2 to 12 carbon atoms, and L² is an alkylene group having 2 to 12 carbon atoms, an alkyloxycarbonylalkyl group of the formula (I-1-2):
L³—O—CO—L⁴— (I-1-2)
in which L³ is an alkyl group having 2 to 12 carbon atoms, and L⁴ is an alkylene group having 2 to 12 carbon atoms, a phenyl group substituted with at least one alkyl group having 1 to 20 carbon atoms, or an alkyl group having 1 to 20 carbon atoms substituted with at least one phenyl group.

5. The positive type red-colored photosensitive composition according to claim 1 or 2, wherein said dye is a compound of the formula (10):

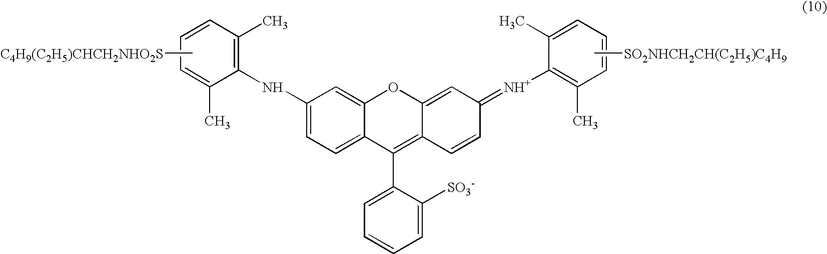

6. The positive type red-colored photosensitive composition according to claim 1 or 2, wherein said dye is at least one compound selected from the group consisting of a compound of the formula (II) or its salt, and a compound of the formula (III) or its salt: 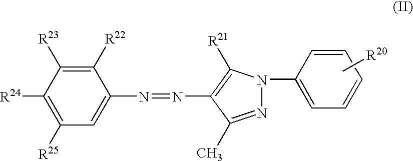
wherein R²¹ and R²² represent independently each other a hydroxyl group or a carboxyl group, and R²⁰, R²³, R²⁴ and R²⁵ represent independently each other a hydrogen atom, a halogen atom, an alkyl group having 1 to 4 carbon atoms, a sulfonic acid group or a nitro group. 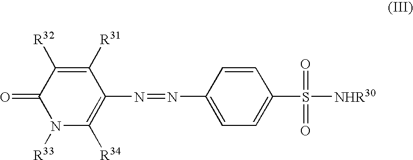
wherein R³⁰ represents an alkyl group having 2 to 10 carbon atoms, R³¹, R³² and R³⁴ represent independently each other a hydrogen atom, a methyl atom, a hydroxyl group or a cyano group, and R³³ represents an alkyl group having 1 to 4 carbon atoms.

7. A color filter comprising pixels formed of a positive type red-colored photosensitive composition according to claim 1.

8. A solid state image pickup device comprising a color filter according to claim 7.
